(19) United States
(12) Patent Application Publication
(10) Pub. No.: US 2007/0030313 A1
(43) Pub. Date: Feb. 8, 2007

(54) Heater of inkjet printhead, inkjet printhead having the heater and method of manufacturing the inkjet printhead

(75) Inventors: Jae-sik Min, Suwon-si (KR); Sang-won Kang, Seongnam-si (KR); Young-ung Ha, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/475,232

(22) Filed: Jun. 27, 2006

(30) Foreign Application Priority Data
Aug. 5, 2005 (KR) 2005-71697

(51) Int. Cl. B41J 2/05

(52) U.S. Cl. 347/62

(57) ABSTRACT

A heater of an inkjet printhead, an inkjet printhead having the heater, and a method of manufacturing the inkjet printhead. The heater is formed of an Ru-M-O alloy in which M is at least one metal selected from the group consisting of Ti, Ta, Pt, Ir, Zr, W, and Hf.

### CROSS-REFERENCE TO RELATED APPLICATIONS

This application claims priority under 35 U.S.C. §119(a) from Korean Patent Application No. 10-2005-0071697, filed on Aug. 5, 2005, in the Korean Intellectual Property Office, the disclosure of which is incorporated herein in its entirety by reference.

### BACKGROUND OF THE INVENTION

1. Field of the Invention

The present general inventive concept relates to an inkjet printhead and a method of manufacturing the inkjet printhead, and more particularly, to an inkjet printhead that has a heater of which a lifespan and a reliability are improved, and a method of manufacturing the inkjet printhead.

2. Description of the Related Art

Generally, an inkjet printer is a device for printing a color image on a printing medium by firing droplets of ink from an inkjet printhead onto a desired location of the printing medium. There are two types of ink jet printers: a shuttle type inkjet printer and a line printing type inkjet printer. The shuttle type inkjet printer has an inkjet printhead that carries out printing as it moves in a direction perpendicular to the printing medium feeding direction. The line printing type inkjet printer is a newly developed, high speed printer that has an array printhead having a width corresponding to the width of a printing medium. The array printhead includes a plurality of inkjet printheads that are arranged in a predetermined pattern. In the line printing type inkjet printer, the array printhead is fixed and a printing medium is fed for printing, so that high speed printing can be realized.

Meanwhile, the inkjet printhead can be classified into two types according to an ejecting mechanism of droplets of ink: a thermal inkjet printhead creates bubbles with heat to eject a droplet of ink by the expansion of the bubbles, and a piezoelectric inkjet printhead includes a piezoelectric material to eject droplets of ink by utilizing a pressure generated by a deformation of the piezoelectric material.

The ink droplet ejecting mechanism of the thermal inkjet printhead will now be more fully described. When a pulse current is applied to a heater formed of a resistive heating material, heat is generated by the heater to immediately increase a temperature of adjoining ink to about 300° C. As a result, a bubble is created and the bubble, as it expands, exerts a pressure on ink in an ink chamber. This pressure pushes the ink out of the ink chamber through a nozzle in the form of a droplet.

FIG. 1 is a schematic sectional view illustrating a conventional thermal inkjet printhead. Referring to FIG. 1, the conventional inkjet printhead includes a substrate 11 having a plurality of stacked material layers, a chamber layer 20 stacked above the substrate 11 to define an ink chamber 22, and a nozzle layer 30 stacked on the chamber layer 20. The ink chamber 22 is provided to contain ink, and a heater 13 is provided under the ink chamber 22 to heat the ink in the ink chamber 22 to create a bubble. The nozzle layer 30 is formed with a nozzle 32 to eject the ink.

On the substrate 11, an insulating layer 12 is formed for thermal and electric insulation between the heater 13 and the substrate 11. On the insulating layer 12, the heater 13 is formed to heat the ink in the ink chamber 22 to create the bubble. The heater 13 may be formed by depositing a material, such as tantalum-aluminum (TaAl) alloy, on the insulating layer 12 as a thin film. On the heater 13, a conductor 14 is formed to apply current to the heater 13. The conductor 14 is formed of a highly conductive metal, such as aluminum (Al).

On the heater 13 and the conductor 14, a passivation layer 15 is formed to protect the heater 13 and the conductor 14. The passivation layer 15 prevents the heater 13 and the conductor 14 from oxidizing and from direct contact with the ink, and generally the passivation layer 15 is formed of silicon nitride (SiNx, where x is a positive real number). On the passivation layer 15, an anti-cavitation layer 16 is formed to protect the heater 13 from a cavitation force generated when the bubble collapses. Generally, the anti-cavitation layer 16 is formed of tantalum (Ta).

Due to recent trends, such as a high integration and a high speed of the printhead, an inkjet printhead that consumes a low amount of power is needed, and particularly, the low power consumption is needed for an array printhead capable of high speed printing. For the low power consumption, a highly efficient heater is needed. However, the conventional thermal inkjet printhead includes the passivation layer 15 formed of low-conductive SiNx on the heater 13 to protect the heater 13, and the anti-cavitation layer 16 formed on the passivation layer 15. The passivation layer 15 and the anti-cavitation layer 16 are obstructive layers that lower the efficiency of the heater 13.

Therefore, the passivation layer 15 and the anti-cavitation layer 16 should be removed in order to increase the efficiency of the heater 13. In this case, the following problems can occur. Since the heater 13 will directly contact the ink, the heater 13 can easily corrode when the heater 13 generates heat. Furthermore, natural oxidation can easily occur on the heater 13 due to water in the ink. The natural oxidation causes the resistance of the heater 13 to change drastically with respect to a variation of input energy to the heater 13. Still further, since the heater directly receives the cavitation force generated when the bubble shrinks, a possibility of damage to the heater 13 due to the cavitation force increases.

### SUMMARY OF THE INVENTION

The present general inventive concept provides an inkjet printhead that has a heater of which a lifespan and a reliability are improved, and a method of manufacturing the inkjet printhead.

The present general inventive concept also provides an inkjet printhead that has a heater formed of a material having a high resistance against corrosion and oxidation and a high toughness to resist a cavitation force generated when a bubble shrinks, and a method of manufacturing the inkjet printhead.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a heater of an inkjet printhead, the heater including an Ru-M-O alloy in which M is at least one metal selected from the group consisting of Ti, Ta, Pt, Ir, Zr, W, and Hf.

The heater may have a resistivity ranging from about 100 μΩcm to about 2000 μΩcm. The heater may have a thickness ranging from about 100 Å to about 5000 Å.

The foregoing and/or other aspects and utilities of the present general inventive concept may also be achieved by providing an inkjet printhead, including a substrate, a heater formed above the substrate in a predetermined shape, a conductor formed to be electrically connected with the heater to apply a current to the heater, a chamber layer stacked above the substrate to define an ink chamber to contain ink to be ejected, and a nozzle layer formed above the chamber layer to form a nozzle to eject the ink, in which the heater is formed of an Ru-M-O alloy in which M is at least one metal selected from the group consisting of Ti, Ta, Pt, Ir, Zr, W, and Hf.

The heater may be located on a bottom surface of the ink chamber to directly contact the ink in the ink chamber. A passivation layer may be formed on surfaces of the heater and the conductor.

An insulating layer may be formed between the substrate and the heater.

The foregoing and/or other aspects and utilities of the present general inventive concept may also be achieved by providing a method of manufacturing an inkjet printhead, including preparing a substrate, forming a heater above the substrate using an Ru-M-O alloy in which M is at least one metal selected from the group consisting of Ti, Ta, Pt, Ir, Zr, W, and Hr, forming a conductor to be electrically connected with the heater, stacking a chamber layer above the substrate to define an ink chamber, and stacking a nozzle layer above the chamber layer to form a nozzle.

The method may further include forming an insulating layer on the substrate.

The heater may be formed by vacuum deposition method selected from sputtering, CVD, ALD, or PEALD.

The method may further include forming a passivation layer on the heater and the conductor after the forming of the conductor.

The foregoing and/or other aspects and utilities of the present general inventive concept may also be achieved by providing a heater useable in an inkjet print head of an image forming apparatus, including at least alloy comprising a metal and a metal oxide and having a resistivity of less than or equal to about 2000 μΩcm.

The metal can have a first resistivity and the metal oxide can have a second resistivity greater than the first resistivity. The metal can have a resistivity of less than about 10 μΩcm and the metal oxide can have a resistivity of less than about 2000 μΩcm. The at least one alloy can be made from a first metal oxide having a resistivity of less than or equal to about 40 μΩcm and a second metal oxide having a resistivity of less than or equal to about 2000 μΩcm. The metal oxide can include a metal selected from Ti, Ta, Pt, Ir, Zr, W, and Hf. The metal can be Ru. The at least one alloy can include Ru—Ta—O. The at least one alloy can include a plurality of alloys.

The foregoing and/or other aspects and utilities of the present general inventive concept may also be achieved by providing a thermal inkjet print head, including a substrate, a heater formed on the substrate to heat ink, the heater including at least one alloy comprising a metal and a metal oxide and having a resistivity of less than or equal to about 2000 μΩcm, a conductor formed on the heater to provide a current to the heater, an ink chamber layer stacked on the substrate to define an ink chamber to contain the ink, and a nozzle layer stacked on the chamber layer and including at least one nozzle to eject the ink.

The resistivity of the heater can remain constant with a variation of a width of an energy pulse input to the heater. The thermal inkjet print head can further include an insulating layer formed between substrate and the heater to provide insulation between the substrate and the heater. The thermal inkjet print head can further include a passivation layer formed on the heater and the conductor to prevent the heater and the conductor from directly contacting the ink.

The foregoing and/or other aspects and utilities of the present general inventive concept may also be achieved by providing a method of making a thermal inkjet print head, including preparing a substrate having a predetermined thickness, forming a heater the substrate to heat ink, the heater including at least one alloy comprising a metal and a metal oxide and having a resistivity of less than or equal to about 2000 μΩcm, forming a conductor the heater to provide a current to the heater, forming a chamber layer on the substrate to define an ink chamber to contain the ink, and forming a nozzle layer on the chamber layer having a nozzle to eject the ink. The methof can further include forming an insulating layer on a top surface of the substrate between the substrate and the heater to provide insulation between the substrate and the heater.

### BRIEF DESCRIPTION OF THE DRAWINGS

The above and/or other aspects and advantages of the present general inventive concept will become apparent and more readily appreciated from the following description of the embodiments, taken in conjunction with the accompanying drawings of which:

FIG. 1 is a schematic sectional view illustrating a convention inkjet printhead;

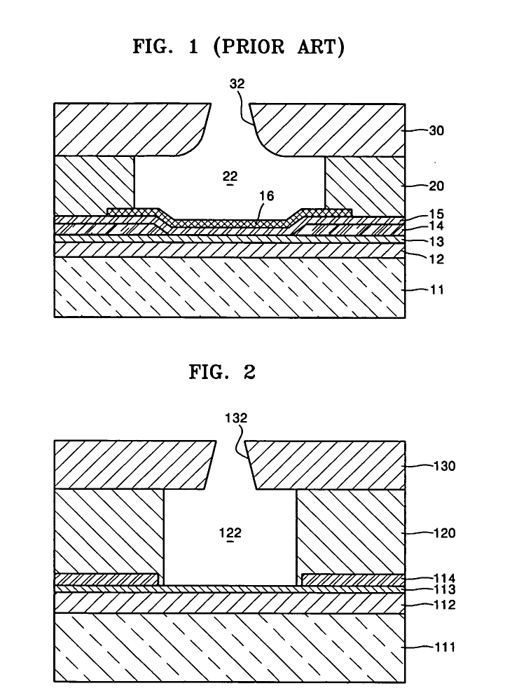

FIG. 2 is a schematic sectional view illustrating a thermal inkjet printhead according to an embodiment of the present general inventive concept;

FIG. 3 is a graph illustrating a heater resistance with respect to a width of an input energy pulse to a heater of the thermal inkjet printhead of FIG. 2 according to an embodiment of the present general inventive concept; and

FIGS. 4A through 4D illustrate a method of manufacturing the thermal inkjet printhead of FIG. 2 according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

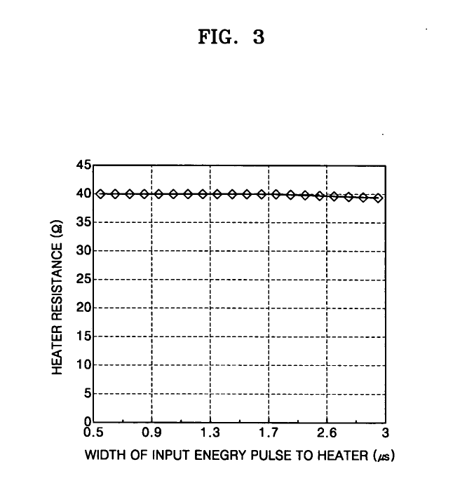

FIG. 2 is a schematic sectional view illustrating a thermal inkjet printhead according to an embodiment of the present general inventive concept.

Referring to FIG. 2, the thermal inkjet printhead according to this embodiment of the present general inventive concept includes a substrate 111 formed with a heater 113 and a conductor 114, a chamber layer 120 stacked on the substrate 111, and a nozzle layer 130 stacked on the chamber layer 120. The substrate 111 can be formed of, for example, a silicon. On a surface of the substrate 111, an insulating layer 112 is formed to provide insulation between the substrate 111 and the heater 113. The insulating layer 112 may be formed of, for example, SiOx or SiNx, where x is a positive real number.

On a top surface of the insulating layer 112, the heater 113 is formed in a predetermined shape to create a bubble by heating ink contained in an ink chamber 122. The heater 113 may be formed of an Ru-M-O alloy. Here, the “M” may be at least one metal selected from the group consisting of Ti, Ta, Pt, Ir, Zr, W, and Hf. The resistivity of the heater 113 can range from about 100 μΩcm to about 2000 μΩcm. Furthermore, a thickness of the heater 113 can range from about 100 Å to about 5000 Å. An amount of the Ru in the alloy can be, for example, about 20 to about 80 atomic percent based on 100 atomic percent of the alloy. An amount of the M in the alloy can be, for example, about 3 to about 25 atomic percent, based on 100 atomic percent of the alloy. An amount of the O in the alloy can be, for example, about 10 to about 60 atomic percent, based on 100 atomic percent of the alloy.

The conductor 114 is formed on a top surface of the heater 113 on both sides of the ink chamber 122 to apply current to the heater 113. The conductor 114 can be formed of a highly conductive metal.

The chamber layer 120 is formed on the heater 113 and the conductor 114 above the substrate 111 to define the ink chamber 122 to receive ink to be ejected. The ink chamber 122 is located on a heat-emitting portion of the heater 113, i.e., on the top surface of the heater 113 exposed through the conductor 114. Here, the heater 113 is located on a bottom of the ink chamber 122 in direct contact with the ink in the ink chamber 122. Meanwhile, in this embodiment, the heater 113, if desired, may be formed such that the heater 113 does not make contact with the ink in the ink chamber 122. In this case, a passivation layer (not illustrated) may be formed on the heater 113 and the conductor 114 to protect the heater 113 and the conductor 114 to prevent direct contact of the heater 113 and the conductor 114 with the ink in the ink chamber 122. The passivation layer may be formed of, for example, SiOx or SiNx, where x is a positive real number. The nozzle layer 130 is stacked on the chamber layer 120 and formed with a nozzle 132 to eject the ink. The nozzle 132 may be formed at a position corresponding to a center of the ink chamber 122.

In the inkjet printhead of this embodiment of the present general inventive concept, the heater 113 can be formed of the Ru-M-O alloy (in which the “M” is at least one metal selected from the group consisting of Ti, Ta, Pt, Ir, Zr, W, and Hf) that has a high resistance against corrosion and oxidation and a high toughness to resist a cavitation force generated when a bubble shrinks.

Specifically, when the heater 113 is formed of, for example, the Ru—Ta—O alloy, the Ru of the Ru—Ta—O alloy combines with oxygen to form RuOx oxide where x is a positive real number (which is a stable conductor), and the Ta also combines with oxygen to form TaOx oxide, where x is a positive real number (which is a stable insulator). Since the Ru—Ta—O alloy is already formed of stable oxides, the heater 113 formed of the Ru—Ta—O alloy does not become oxidized or only can become very slightly oxidized by contact with the ink. Therefore, a natural oxidation of the heater 113 by the ink, which causes a great variation in a resistance of the heater 113, does not occur. Further, since the RuOx oxide hardly reacts on the ink (if at all), the heater 113 is not corroded by contact with the ink.

Meanwhile, although a resistivity of most materials drastically increases hundreds of thousands of times when the metals are oxidized, a resistivity of Ru increases only about five times when oxidized. Specifically, the resistivity of the Ru is about 7.1 μΩcm, and the resistivity of the RuOx is about 35.2 μΩcm to about 40 μΩcm. Meanwhile, the TaOx, which is an insulator, included in the Ru—Ta—O alloy increases the resistivity of the Ru—Ta—O alloy, so that the Ru—Ta—O alloy can have a suitable resistivity, for example, about 100 μΩcm to about 2000 μΩcm. Further, since the TaOx has a high toughness, the heater 113 formed of the Ru—Ta—O alloy can resist against the cavitation force generating when the bubble shrinks, thereby decreasing the possibility of damage to the heater 113.

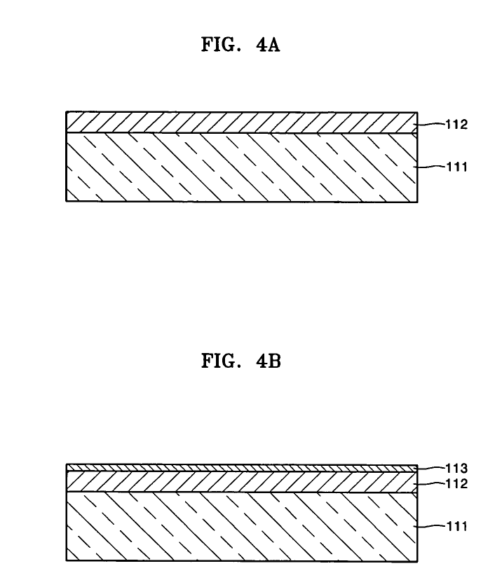

FIG. 3 is a graph illustrating a heater resistance with respect to a width of an input energy pulse to the heater 113 of FIG. 2 when the heater 113 is formed of the Ru—Ta—O alloy. Here, the heater 113 is formed in a strip shape with a heat-emitting area of 672 μm2. Referring to FIG. 3, it can be seen that the resistivity of the heater 113 is kept constant regardless of the width of input energy pulse to heater 113. This illustrates that natural oxidation does not occur on the heater 113.

As mentioned above, when the heater 113 is formed of the Ru-M-O alloy (where the M is at least one metal selected from the group consisting of Ti, Ta, Pt, Ir, Zr, W, and Hf), the heater 113 is not corroded even when it is in direct contact with ink and also the heater 113 is not oxidized. Further, the heater 113 has a high toughness, thereby reducing the possibility of damage to the heater 113 by the cavitation force generated when a bubble shrinks.

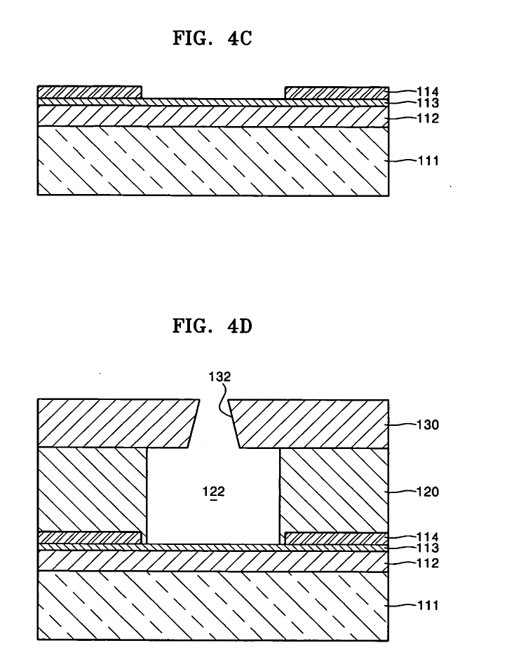

Hereinafter, referring to FIGS. 4A through 4D, a method of manufacturing the inkjet printhead of FIG. 2 will be described according to an embodiment of the present general inventive concept.

First, referring to FIG. 4A, a substrate 111 with a predetermined thickness is prepared, and an insulating layer 112 is formed on a top surface of the substrate 111. Here, a silicon substrate can be used for the substrate 111, and the insulating layer 112 may be formed of SiOx or SiNx where x is a positive real number.

Referring to FIG. 4B, a heater 113 is formed on a top surface of the insulating layer 112 in a predetermined shape. The heater 113 is formed of the Ru-M-O alloy where the M may be at least one metal selected from the group consisting of Ti, Ta, Pt, Ir, Zr, W, and Hf. The heater 113 can be formed to have a resistivity of 100 ∥Ωcm to 2000 μΩcm and a thickness of thickness of 100 Å to 5000 Å.

The heater 113 may be formed by a vacuum deposition method, such as sputtering, chemical vapour deposition (CVD), atomic laser deposition (ALD), or plasma enhanced atomic layer deposition (PEALD). For example, to form the heater 113 of the Ru—Ti—O alloy by the sputtering, an oxygen/argon gas is injected into a chamber in which an RuTix target is mounted, and the RuTix target is reactively sputtered to form an Ru—Ti—O alloy thin film on a top surface of the insulating layer 112 formed on the substrate 111. Meanwhile, the Ru—Ti—O alloy thin film can be formed on the top surface of the insulating layer 112 by mounting an Ru target and a Ti target in a chamber and reactively sputtering the Ru target in the presence of the oxygen/argon gas and then reactively sputtering the Ti target in the presence of an argon gas in sequence. Further, to form the heater 113 of the Ru—Ti—O alloy by the ALD, an Ru source and an oxygen source are supplied to form an RuOx thin film, and a Ti source and an oxygen source are supplied to form a TiOx thin film. Here, the supplying operations to form the RuOx thin film and the TiOx thin film can be performed alternately or at the same time to form the Ru—Ti—O alloy thin film on a top surface of the insulating layer 112 formed on the substrate 111.

Referring to FIG. 4C, a conductor 114 is formed on a top surface of the heater 113 at both sides of a space that will become the ink chamber 122. The conductor 114 is electrically connected with the heater 113 to apply current to the heater 113. The conductor 114 may be formed on the top surface of the heater 113 by depositing a highly conductive metal and patterning the metal. Meanwhile, though not illustrated in FIG. 4C, a passivation layer can be further formed on the heater 113 and the conductor 114 to protect the heater 113 and the conductor 114, if desired. The passivation layer may be formed of SiOx or SiNx, where x is a positive real number.

Referring to FIG. 4D, a chamber layer 120 is stacked above the insulating layer 112 where the heater 113 and the conductor 114 are formed to define an ink chamber 122 to contain ink. On the chamber layer 120, a nozzle layer 130 is stacked to form a nozzle 132 to eject the ink. The ink chamber 122 is formed on a top portion of the heater 113 that is exposed through the conductor 114, and the nozzle 132 can be formed at a position corresponding to the center of the ink chamber 122. The chamber layer 120 may be formed to cover the conductor 114 by stacking a predetermined material, such as polymer, above the insulating layer 112 to a predetermined thickness and patterning the stacked predetermined material. The nozzle layer 130 may be formed by stacking a predetermined material, such as polymer, to a predetermined thickness and patterning the stacked predetermined material.

As described above, according to the present general inventive concept, a heater of a thermal inkjet print head is formed of the Ru-M-O alloy so that the heater is not corroded or oxidized by ink even when the heater is in direct contact with the ink. Further, a high toughness of the Ru-M-O alloy reduces a possibility of damage to the heater due to a cavitation force generated when an ink bubble formed when the heater heats ink shrinks. Therefore, the a lifespan and reliability of the heater can be improved. Furthermore, the heater can heat the ink while being in direct contact with the ink, thereby increasing an efficiency of the heater. This increase of the heater efficiency enables a low power operation of the inkjet printhead, especially, an array printhead. Further, the lower power operation of the inkjet printhead enables a high integration of the nozzle. Furthermore, since a formation of a passivation layer on the heater is not needed, the inkjet printhead can be manufactured through a simple process.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A heater of an inkjet printhead to create a bubble by heating ink, the heater comprising:
an Ru-M-O alloy in which M is at least one metal selected from the group consisting of Ti, Ta, Pt, Ir, Zr, W, and Hf.

2. The heater of claim 1, wherein the heater has a resistivity ranging from about 100 μΩcm to about 2000 μΩcm.

3. The heater of claim 1, wherein the heater has a thickness ranging from about 100 Å to about 5000 Å.

4. An inkjet printhead, comprising:
a substrate;
a heater formed above the substrate in a predetermined shape;
a conductor formed to be electrically connected with the heater to apply a current to the heater;
a chamber layer stacked above the substrate to define an ink chamber to contain ink to be ejected; and
a nozzle layer formed above the chamber layer to form a nozzle to eject the ink,
wherein the heater is formed of an Ru-M-O alloy in which M is at least one metal selected from the group consisting of Ti, Ta, Pt, Ir, Zr, W, and Hf.

5. The inkjet printhead of claim 4, wherein the heater has a resistivity ranging from about 100 μΩcm to about 2000 μΩcm.

6. The inkjet printhead of claim 4, wherein the heater has a thickness ranging from about 100 Å to about 5000 Å.

7. The inkjet printhead of claim 4, wherein the heater is located on a bottom surface of the ink chamber to directly contact the ink in the ink chamber.

8. The inkjet printhead of claim 4, wherein a passivation layer is formed on the heater and the conductor.

9. The inkjet printhead of claim 8, wherein the passivation layer is formed of SiNₓ or SiOₓ, where x is a positive real number.

10. The inkjet printhead of claim 4, wherein an insulating layer is formed between the substrate and the heater.

11. The inkjet printhead of claim 10, wherein the insulating layer is formed of SiNₓ or SiOₓ, where x is a positive real number.

12. A method of manufacturing an inkjet printhead, comprising:
preparing a substrate;
forming a heater above the substrate using an Ru-M-O alloy in which M is at least one metal selected from the group consisting of Ti, Ta, Pt, Ir, Zr, W, and Hr;
forming a conductor to be electrically connected with the heater;
stacking a chamber layer above the substrate to define an ink chamber; and
stacking a nozzle layer above the chamber layer to form a nozzle.

13. The method of claim 12, further comprising:
forming an insulating layer on the substrate.

14. The method of claim 13, wherein the insulating layer is formed of SiNₓ or SiOₓ, where x is a positive real number.

15. The method of claim 12, wherein the heater is formed to have a resistivity ranging from about 100 μΩcm to about 2000 μΩcm.

16. The method of claim 12, wherein the heater is formed to have a thickness ranging from about 100 Å to about 5000 Å.

17. The method of claim 12, wherein the heater is formed by a vacuum deposition method.

18. The method of claim 17, wherein the vacuum deposition method is sputtering, chemical vapor deposition, ALD atomic layer deposition, or PEALD plasma enhanced atomic layer deposition.

19. The method of claim 12, further comprising:
forming a passivation layer on the heater and the conductor after the forming of the conductor.

20. The method of claim 19, wherein the passivation layer is formed of SiNₓ or SiOₓ where x is a positive real number.
